(19) United States
(12) Patent Application Publication
(10) Pub. No.: US 2025/0362761 A1
(43) Pub. Date: Nov. 27, 2025

(54) INTELLIGENT PRESENTATION POINTERS

(71) Applicant: Andrew Shinruei Cheng, Cupertino, CA (US)

(72) Inventor: Andrew Shinruei Cheng, Cupertino, CA (US)

(21) Appl. No.: 18/955,491

(22) Filed: Nov. 21, 2024

Related U.S. Application Data
(60) Provisional application No. 63/650,629, filed on May 22, 2024.

(51) Int. Cl. G06F 3/0354; G06F 3/038; G06T 7/70

(52) U.S. Cl. CPC G06F 3/03542; G06F 3/038; G06T 7/70

(57) ABSTRACT

An intelligent presentation pointer comprises a camera, one or more processing circuits, and a transmitter. When a presenter points the presentation pointer at a location on a presentation screen, the camera is configured to capture an image of the location on the presentation screen. The processor is configured to process the captured image to obtain information of the captured image. The transmitter is configured to transmit the information of the captured image to a hosting device of the presentation, to enable the hosting device to display an emulated laser spot in a concurrent virtual session or on both the in-person projection screen and concurrent virtual session(s).

### RELATED APPLICATIONS

This application claims priority to U.S. Provisional Application 63/650,629 filed on May 22, 2024, the entire content of which is incorporated herein in its entirety.

### FIELD OF THE INVENTION

The present disclosure relates generally to electronic devices, and more specifically, to intelligent presentation pointers and stylus.

### BACKGROUND

When giving a presentation at an in-person conference, the presenter frequently uses a pointer, for example, a laser pointer, to emphasize a point of interest on the display screen of the presentation. The display screen may be a large projection screen or a large liquid crystal display (LCD) screen. To highlight the point of interest on the display screen, the presenter points the laser pointer to the location where they want to emphasize. The bright spot created by the laser beam on the display screen draws the attention of the audience.

During the Covid pandemic, most conferences shifted from in-person to completely virtual, where presentations were given online in virtual conferences. Some presentation software, for example, PowerPoint, has a built-in functionality of tracking the mouse movement on the hosting computer and displaying a virtual laser spot on the online presentation for all participants to see and follow. After the pandemic, although in-person conferences have mostly returned, online concurrent sessions remain a preferred option of many attendees, for reasons related to concerns of health, environment, or costs. Often, during a concurrent virtual presentation, an attendee would be shown a presentation that is synchronized with the presentation at in-person session and accompanied by the audio signal from the presenter. Information related to the emphases and highlights made by the presenter using a laser pointer at the in-person session would be lost in the concurrent virtual presentation session.

### SUMMARY

Accordingly, it is an objective of the present application to disclose an intelligent presentation pointer that can convert a point of interest highlighted on a projection screen into a virtual laser spot for a concurrent virtual presentation or for both an in-person and its concurrent virtual presentations. In some embodiments, the intelligent presentation pointer comprises a camera, one or more processing circuits, and a transmitter. The camera is configured to capture an image of a screen pointed at by the presentation pointer. The one or more processing circuits are configured to process the captured image to obtain information of the captured image. The transmitter is configured to transmit the obtained information of the captured image to a hosting device of a presentation. The camera may be a wide-angle camera, a narrow-angle camera, or a zoom camera, and the captured image may be more than a whole screen, a whole screen, or a partial screen of the screen pointed at by the presentation pointer.

In some embodiments, the information of the captured image comprises the captured image. In some embodiments, the information of the captured image comprises the coordinates of the center of the image of the screen pointed at by the presentation pointer, relative to the screen. In some embodiments, the information of the captured image comprises an area surrounding the center of the image of the screen pointed at by the presentation pointer. In some embodiments, when the information of the captured image comprises a small portion of the screen surrounding the location pointed at by the presentation pointer, the processing circuits in the presentation pointer or the hosting device compares the captured image to the projection image to obtain the coordinates of the center of the captured image relative to the projection screen. The center of the captured image is reproduced as a virtual laser spot on a concurrent virtual presentation or on both an in-person presentation and a concurrent virtual presentation or virtual presentations.

In some embodiments, the presentation pointer further comprises a light source that is configured to transmit a light beam to the screen pointed by the presentation pointer and the captured image comprises a center of the location as marked by the light beam.

In some embodiments, the camera is configured to capture consecutively a plurality of images of the screen pointed at by the presentation pointer that is being held and moved by a presenter, and the processors are configured to obtain information of each image in the plurality of images for transmission by the transmitter. In some embodiments, the camera is configured to capture continuously the plurality of images at a frame rate. The frame rate may be approximately 5-120 frames per second in some embodiments.

In some embodiments, a presentation system includes a stylus and a hosting device. The stylus comprises a camera, one or more processing circuits, and a transmitter. The hosting device is configured to play a presentation on a first screen. The first screen may be a projection screen, a TV screen, or a computer screen. The camera is configured to capture an image of a location on a presentation screen towards which the stylus is pointed. The one or more processing circuits of the stylus are configured to process the captured image to obtain information of the captured image. The transmitter is configured to transmit the information of the captured image to the hosting device. In one embodiment, the hosting device is configured to receive the information of the captured image and display an indication of the location on the presentation on the first screen. In one embodiment, the indication of the location may be displayed on a second screen of a device participating in a virtual session of the presentation. In one embodiment, the indication of the location may be displayed both on the second and the first screen. The indication of the location may be a virtual laser spot or a bright spot emulating a laser pointer.

In some embodiments, the one or more processing circuits are configured to obtain the coordinates of the center of the captured image relative to the projection screen. For example, the processor processes the captured image to obtain the center of the captured image and to obtain the image of the projection screen from the captured image, to derive the coordinates of the center of the captured image relative to the projection screen. In one embodiment, the processors are configured to obtain a small area around the center of the captured image. The small area around the center of the captured image is compared to an image of the projection screen and the coordinates of the center of the captured image relative to the projection screen are obtained based on the comparison. It is noted that the process of deriving the coordinates of the center of the captured image can be carried out by the one or more processing circuits of the stylus or by the hosting device.

In some embodiments, the camera is configured to capture consecutively a plurality of images of the screen pointed at by the stylus when the stylus is held and moved by a presenter. The processors are configured to obtain information of each image in the plurality of images for transmission by the transmitter. In some embodiments, the camera is configured to capture continuously the plurality of images at a frame rate. The frame rate may be constant or variable. In some embodiments, the frame rate may be approximately 5-120 frames per second.

In some embodiments of the presentation system, the camera installed in the stylus may be a wide-angle camera, a narrow-angle camera, or a zoom camera. Depending on the type of camera, the image of the presentation captured by the camera may be a whole screen or a partial screen of the presentation, or more than a whole screen of the presentation. In one embodiment, the stylus further comprises a light source, where the light source is configured to transmit a light beam to the screen pointed by the presentation pointer. In one embodiment, the hosting device only displays an indication of the location pointed at by the presentation pointer on the second screen of the device participating in a virtual session of the presentation, to emulate a laser spot. In another embodiment, the indication of the location pointed at by the presentation device may be displayed on the first and second screen.

### BRIEF DESCRIPTION OF THE DRAWINGS

These and other features of the present disclosure will become readily apparent upon further review of the following specification and drawings. In the drawings, like reference numerals designate corresponding parts throughout the views. Moreover, components in the drawings are not necessarily drawn to scale, the emphasis instead being placed upon clearly illustrating the principles of the present disclosure.

FIG. 1(a) is an illustration of a laser pointer pointing at a presentation displayed on a projection screen.

FIG. 1(b) illustrates an example laser pointer.

FIG. 1(c) illustrates a virtual laser spot displayed on a computer screen.

FIG. 2(a) illustrates an embodiment of an intelligent presentation pointer disclosed in the present application.

FIG. 2(b) is a block diagram illustrating another embodiment of an intelligent presentation pointer disclosed in the present application.

FIG. 3(a) is a flow chart illustrating an operation process of an intelligent presentation pointer according to an embodiment of the present application.

FIG. 3(b) is a flow chart illustrating an operation process of a hosting device according to an embodiment of the present application.

FIG. 3(c) is a flow chart illustrating an operation process of a presentation system according to an embodiment of the present application.

FIGS. 4(a)-4(c) illustrate an example process for determining the coordinates of a center point of the captured image according to an embodiment of the present application. FIG. 5(a) illustrates a use case of an intelligent presentation pointer according to an embodiment in the present application.

FIG. 5(b) illustrates another use case of an intelligent presentation pointer according to an embodiment of the present application

FIG. 6 is a block diagram illustrating a hosting device according to an embodiment of the present application.

### DETAILED DESCRIPTION

Embodiments of the disclosure are described more fully hereinafter with reference to the accompanying drawings, in which preferred embodiments of the disclosure are shown. The various embodiments of the disclosure may, however, be embodied in many different forms and should not be construed as limited to the embodiments set forth herein. Rather, these embodiments are provided so that this disclosure will be thorough and complete, and will fully convey the scope of the disclosure to those skilled in the art.

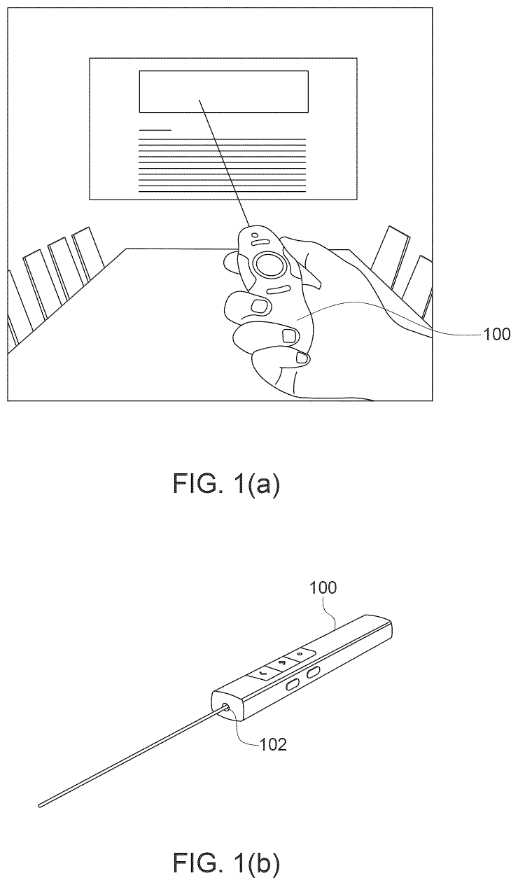

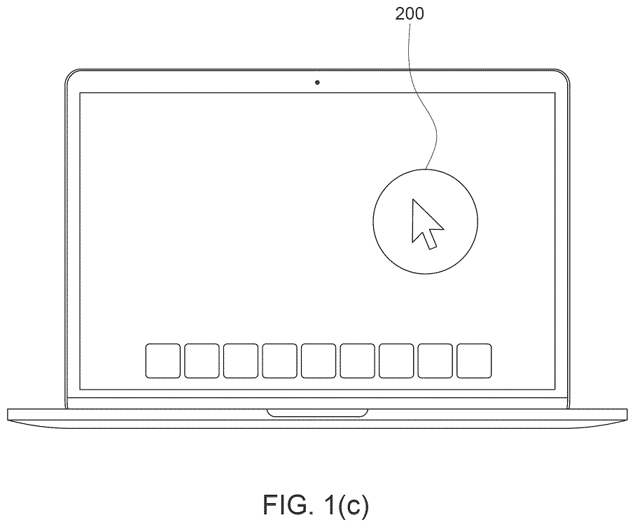

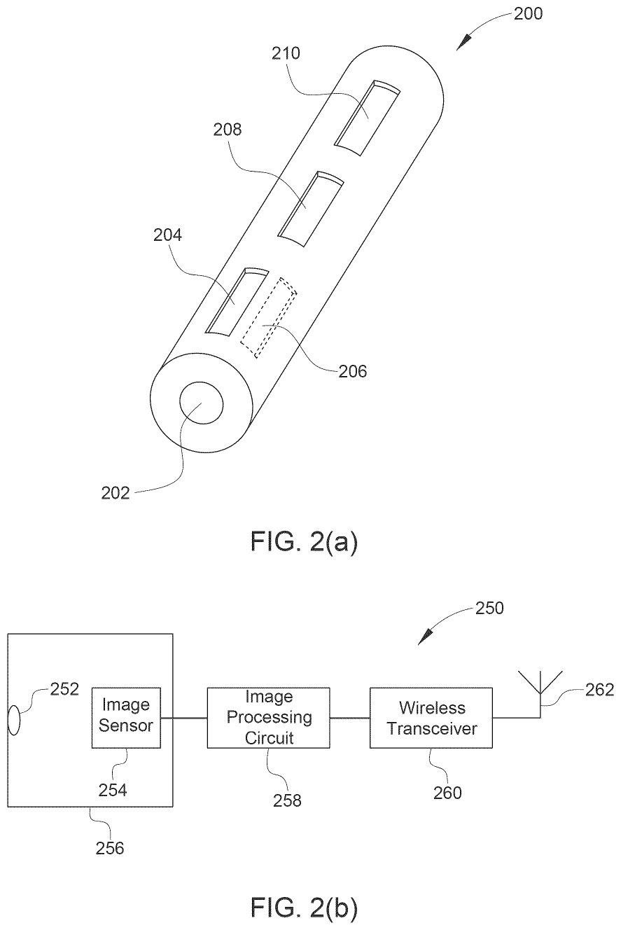

In referring to FIG. 1(a) and FIG. 1(b), a laser pointer 100 is a presentation tool that can be used by a presenter to emphasize a point of interest on a large display screen during an in-person presentation. The display screen can be a projection screen or a HD/LCD TV screen. The laser pointer 100 is equipped with a laser emitter 102 that emits a laser beam during operation. The laser beam produces a bright spot on the screen where the laser pointer 100 is pointed. However, the highlighted spot on the screen cannot be reproduced on a concurrent presentation, unless the video of the in-person presentation is streamed to the virtual session.

FIG. 1(c) illustrates a virtual laser spot displayed on an online presentation, a functionality provided by some presentation software. The virtual laser spot tracks the movement of the mouse on the hosting device and is produced on the presentation slide on every attendee's device. What is urgently needed is a presentation device or system that can integrate the equipment in both environments depicted in FIG. 1(a) and FIG. 1(c) to allow the highlighted spot on a projection or TV screen to be displayed on a computer screen participating in a concurrent online presentation.

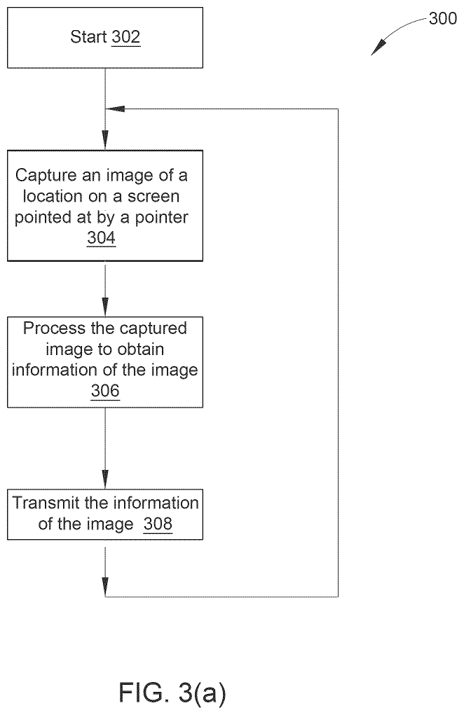

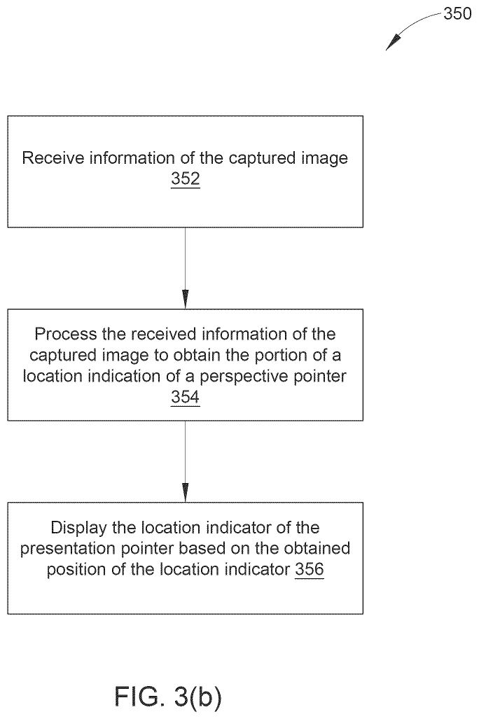

In referring to FIG. 2(a), an intelligent presentation pointer 200 is configured to capture a point of interest such as a highlighted spot on a projection or TV screen during a live presentation and send relevant information to a hosting device so that a virtual spot can be reproduced on a concurrent online session. In some embodiments, the virtual spot can also be reproduced on the projection screen or TV screen at the live session. As shown in FIG. 2(a), an embodiment of the intelligent presentation pointer 200 includes a lens 202, an image sensor 204, a light source 206, which may be optional, a processor 208 comprising one or more processing circuits, and a transmitter 210.

The pointer 200 may include an on/off switch (not shown). When the pointer 200 is turned on, the lens 202 is configured to capture an image of a location on a presentation screen pointed at by the pointer 200. In some embodiments, the pointer 200 includes a light source 206 such as a laser emitter. The light source 206 produces a light beam that shines on the location pointed at by the pointer 200 and highlights the point of interested to which the presenter wants to draw the audience's attention. The lens 202 captures the highlighted spot along with the peripheral area in the immediate vicinity of the highlighted spot. The size of the captured image depends on the lens 202. In some embodiments, the pointer 200 does not include the light source 206 and the lens 202 captures an image of what is directly in front of the pointer 200.

The lens 202 and the image sensor 204 together may form what is usually referred to as a camera. The camera can be a wide-angle camera, a narrow-angle camera, a zoom camera, or any type of camera that is suitable. The size of the field of view (FOV) and the focal length of the camera determine the size of the captured image. A wide-angle camera has a large FOV while a narrow-angle camera has a small FOV. The focal length of a zoom camera is adjustable. By configuring the camera, the size of the captured image can be either pre-configured or adjustable in real time.

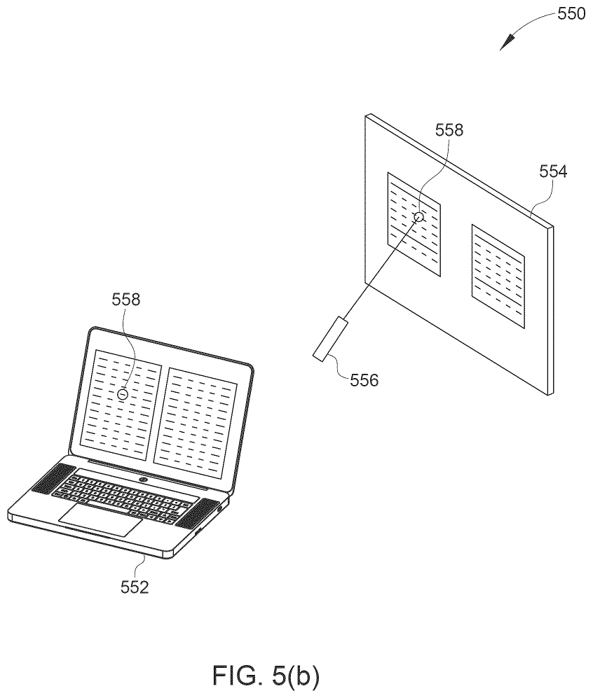

The processing circuits 208 are configured to process the captured image and obtain information of the captured image. The transceiver 210 is configured to transmit the information of the captured image to a hosting device of the presentation (see FIGS. 5(a)-5(b)). The hosting device utilizes the information of the captured image to reproduce a highlighted spot, to emulate a laser spot, on the presentation of a concurrent virtual session or concurrent virtual sessions, and in some embodiments, on the presentation of the live session.

In some embodiments, the processing circuits 208 are configured to process the captured image to adjust the image properties, such as resolution or file size, according to a preset criterion. The information of the captured image is a processed image file and includes the captured image whose properties may have been altered.

In some embodiments, the processing circuits 208 are configured to process the captured image and calculate the coordinates of the center of the captured image in relation to the display screen. The coordinates of the center of the captured image are sent by the transceiver 210 to a hosting device of the presentation as the information of the captured image so that the hosting device can produce a virtual laser spot on the presentation.

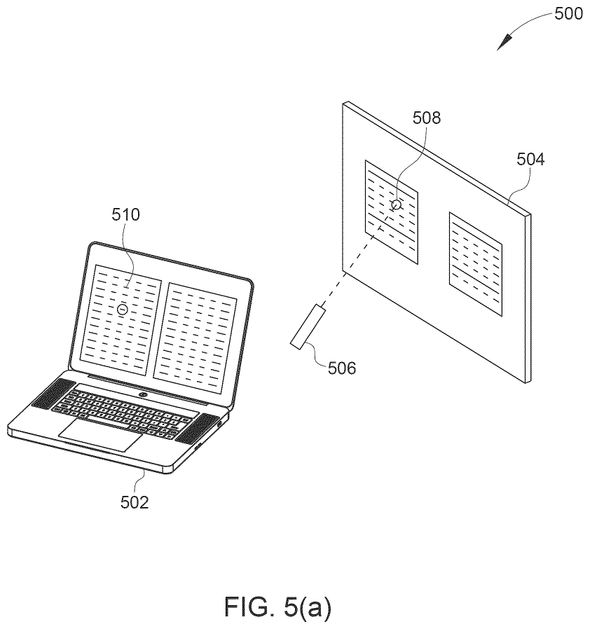

In some embodiments, when the size of the captured image is relatively large so that the captured image includes the entire projection screen, the processor 208 is configured to obtain the coordinates of the center of the captured image relative to the projection screen. In some embodiments, when the size of the captured image is relatively small, for example, not including the entire projection screen, the processor 208 is programmed to extract from the captured image a small portion image of an area surrounding the center of the captured image, i.e., the location pointed at by the presentation pointer. After receiving the extracted small portion image, the hosting device compares the small portion image to the projection screen image or the presentation slide to obtain the coordinates of the center of the captured image, i.e. the location pointed at by the presentation pointer, relative to the projection screen or the slide. The hosting device displays an indication at the location determined by the coordinates, which represent the point of interest intended by the presenter, on the in-person presentation screen and/or virtual session screens. The light source 206 is optional. when a light source 206 generates a bright spot on the display screen, the hosting device only needs to display an indication of the location determined by the coordinates on the virtual session screens. For an example of how to calculate the coordinates of the center of the captured image, see FIGS. 4(a)-4(c).

In some embodiments, the information of the captured image obtained by the processing circuits 208 may include other types of information required or requested by the hosting device.

FIG. 2(b) illustrates a second embodiment of the intelligent presentation pointer 250. In FIG. 2(b), the intelligent presentation pointer 250 includes a lens 252, an image sensor 254, image processing circuits 258, and a wireless transceiver 260. The lens 252 and the image sensor 254 form a camera 256, which may be a narrow-angle or zoom camera. In FIG. 2(b), the camera 256 is configured to capture an image that is relatively small in dimension, for example, comparable to the size of a point of interest that is intended to be highlighted or emphasized by the presenter. For instance, the size of the image may be comparable to a laser spot in one embodiment. In another embodiment, the size of the captured image may be adjustable and is comparable to the size of a point of interest that is intended to be highlighted or emphasized by the presenter.

The light source 206 in FIG. 2(a) may be optional. In some embodiments, the presenter can turn off the light source 206, for instance, when there is no audience in the presentation room. In some embodiments, the light source 206 is not included in the intelligent presentation pointer 250, which may be referred to as stylus herein.

In FIG. 2(b), the camera 256 captures an image of the point of interest on the presentation. The image processing circuits 258 are configured to process the image to obtain information of the captured image and the wireless transceiver 260 is configured to transmit the information of the captured image via an antenna 262 to a hosting device (not shown in FIG. 2(b)).

The wireless transceiver 260 may communicate with the hosting device via Wi-Fi, Bluetooth, near-field communication (NFC), radio-frequency identification (RFID), cellular, etc., which is not limited herein.

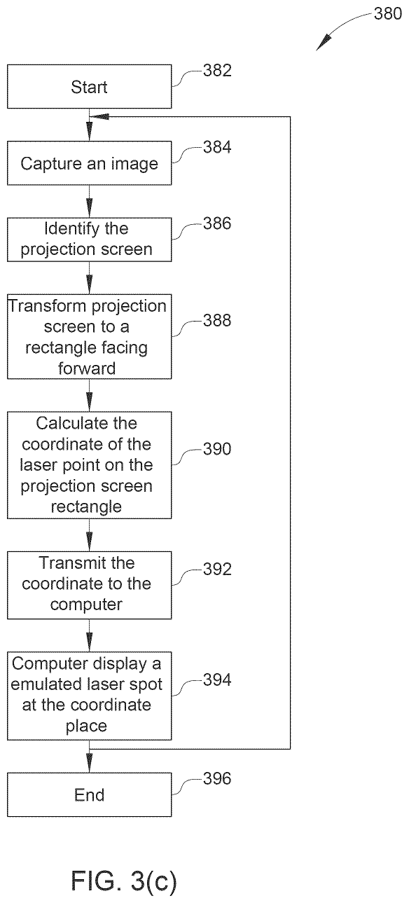

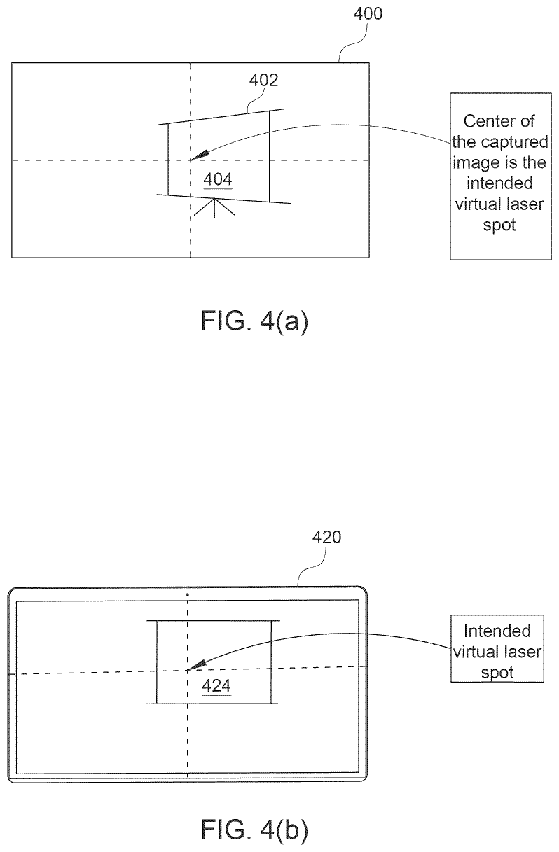

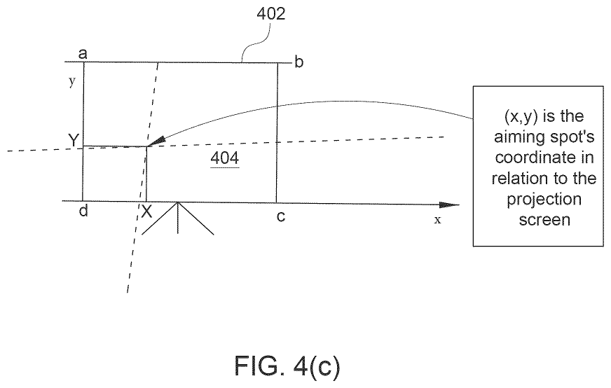

FIG. 3(a) is a flow chart 300 illustrating an operation process in the presentation pointer 250. When turned on (step 302), the camera 256 is configured to capture, continuously or consecutively, a series of images, at a regular interval (step 304), of a location on a presentation screen that is pointed at by the pointer 250. The frame rate of the camera 256 is not limited. In one example, the camera 256 may operate at a frame rate between 5-120 frames per second. The images are consecutive to track the movement of the pointer 250. Each captured image is processed by the image processing circuits 258 to obtain information of the image (step 306). The information of each captured image is transmitted by the wireless transceiver 260 to a hosting device of the presentation (step 308). As the camera 256 continuously captures a series of images, the flow chart 300 repeats itself in a loop.

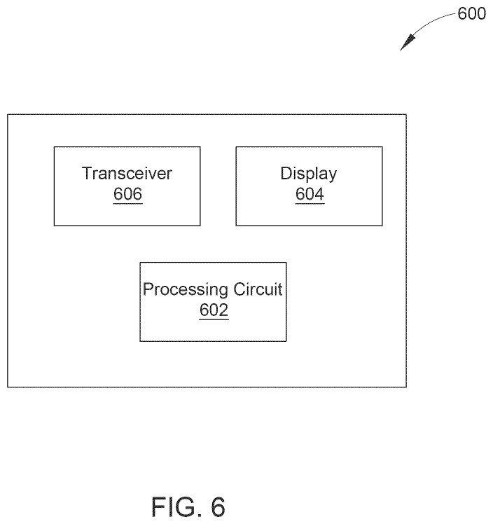

FIG. 3(b) is a flow chart 350 illustrating an operation process in a hosting device (e.g., 600 in FIG. 6). The hosting device 600 receives information of a captured image from the intelligent presentation pointer 250 (step 352). The hosting device 600 processes the received information of the captured image to obtain the position of a location pointed at by the pointer 250 (step 354) and display the location on the presentation in a concurrent virtual session based on the position of the location (step 356).

In some embodiment, the location may be the center of the captured image and the position of the location may be presented as coordinates in a coordinate system using the corners of the projection screen or TV screen as reference.

FIGS. 4(a)-FIG. 4(c) illustrates an embodiment of a calculation method for determining the position of the virtual laser spot for the virtual session or sessions. FIG. 4(a) shows a captured image 400 of a projection or TV screen 402. The image 400 is larger than the screen 402. The center of the captured image is 404, which will be reproduced as a virtual laser spot 424 on a virtual presentation shown in FIG. 4(b). In some embodiments, the captured image 400 encompasses the entire projection screen or TV screen 402. In other embodiments, the captured image 400 may be smaller than or about the same as the screen 402.

In some embodiments, the image processing circuits 258 calculates the coordinates of the center of the captured image 404 and sends the coordinates as the information of the captured image to the hosting device (e.g., 600 in FIG. 6) for reproduction of the virtual laser spot 424. In some embodiments, the hosting device is configured to process the information of the captured image and obtain the position of the virtual lase spot.

FIG. 4(c) illustrates an example process of deriving the coordinates of the center of the image relative to the corners of the screen. FIG. 4(c) displays a presentation in a full screen mode. The derivation may be carried out by the processing circuit 208 in the pointer 200, or the image processing circuits 258 in the pointer 250, or by the hosting device 600. In FIG. 4(a), the captured image 400 comprises the projection screen 402 and the background surrounding the projection screen 402. The center 404 of the captured image 400 is located near the lower left corner of the screen 402. To calculate the coordinates of the center 404, the four corners of the screen 402, a, b, c, and d, are first identified in the captured image 400 as shown in FIG. 4(c). By using a coordinate system that uses point d as the origin, the line connecting point d and c as x axis, and the line connecting point d and point a as y axis, the coordinates of the center 404 (X, Y) can be determined respectively as the distance of the center 404 to the y axis and the distance of the center 404 to the x axis.

The above process assumes that the presentation pointer 250 is pointing straight at the screen 402 when the image is captured. Under this scenario, the screen 402 appears as a rectangle inside the captured image. If the presentation pointer 250 is not pointing straight at the screen 402 when the image is captured, the screen 402 will appear as a parallelogram as shown in FIG. 4(a). Under this scenario, the parallelogram is transformed into a rectangle first so that the screen 402 appears facing forward in the captured image.

In one embodiment, the process of identifying the four corners of the screen 402 may employ image recognition algorithms. For instance, a projection screen may have a thick black border that can be used to mark the boundary for the screen and the four right angles along the border would be identified as the corners of the screen 402. In another embodiment, brightness may be used to differentiate a bright screen that is turned on from the surrounding background. For example, the sudden decrease of pixel brightness marks the transition from the screen to the surrounding background.

After the coordinates of the center 404 are determined in the coordinate system formed by the edges of the projection screen in the captured image, the coordinates can be used to produce a virtual laser spot 424 as shown in FIG. 4(b).

In some embodiments, the captured image may include only a small portion of the presentation screen. To obtain the position of the center of the captured image, the hosting device 600 may be configured to compare the captured image with the presentation slide that is on display and identify the position of the captured image relative to the entire presentation slide. In these embodiments, the coordinate system used in FIG. 4(c) may be formed by the edges of the presentation slide and the calculation process of the coordinates is similar to the calculation process described above.

FIG. 3(c) is a flow chart 380 that summarizes an operation process in an embodiment of the presentation system shown in FIGS. 4(a)-4(b) or FIGS. 5(a)-5(b). In step 382, the presentation pointer 250 is turned on and the camera 256 starts to capture images. One image is captured (step 384) and the image processing circuits 258 process the captured image to identity the projection screen (step 386). If the projection screen appears to be a parallelogram in the captured image, the processing circuits 258 transforms the projection screen into a rectangle facing forward (optional step 388). The processing circuits 258 calculate the coordinates of the center of the captured image, which would be the laser point if the presentation pointer 250 is equipped with a laser, using the rectangle formed by the edges of the projection screen as the coordinate system (step 390). The coordinates are then transmitted to the hosting device 600 of the presentation (step 392) and the hosting device displays an emulated laser spot on the presentation in a virtual session (step 394). Steps 384-394 are repeated when the camera 256 captures a next image. The process 380 ends when the presentation pointer is turned off (step 396).

In another embodiment, step 388 and step 390 may be performed by the hosting device 600 and in step 392, the captured image itself is transmitted to the hosting device 600 by the presentation pointer 250.

FIG. 5(a) and FIG. 5(b) illustrate the differences between a stylus 506 and a laser pointer 556. In FIG. 5(a), the display screen 504 displays a presentation. The display screen 504 may be a projector screen or a computer screen. The presenter uses the stylus 506 to point to points of interest on the screen 504. The stylus 506 does not emit a light beam. When the stylus 506 is pointed at the screen 504, the camera in the stylus 506 captures an image of the spot 508 as the point of interest emphasized by the presenter. The captured image is processed and the information of the captured image is transmitted to a hosting device 502. The hosting device 502 is a device running a presentation software and/or participating in a concurrent virtual session of the presentation. The information of the captured image is used by the hosting device 502 to produce a virtual spot 510 on the online presentation.

In FIG. 5(b), the presenter uses a presentation pointer 556 that is equipped with a light source. The light source may be a laser emitter or other types of suitable light sources. The point of interest on the screen 554 is highlighted by a bright spot 558 formed by a light beam emitted from the light source when the pointer 556 is pointed to the presentation. The captured image may include the bright spot 558 and a small area surrounding the bright spot 558. Alternatively, the captured image may include the entire presentation screen with the point of interest highlighted by the light source. The bright spot 558 is reproduced on the hosting device 552 as an emulated light spot 558.

FIG. 6 is a block diagram illustrating an example hosting device 600. The hosting device 600 comprises one or more processing circuits 602, a display 604, and a transceiver 606. The transceiver 606 is configured to receive information of a captured image from a presentation pointer 200, 250, 506, or 556. The processor 606 is configured to process the received information of the captured image to obtain the position of a location indication showing the spot where the presentation pointer 200, 250, 506, or 556 points at. The processor 606 then displays a virtual spot emulating a light spot on the display 604 based on the obtained location indication.

Although the disclosure is illustrated and described herein with reference to specific embodiments, the disclosure is not intended to be limited to the details shown. Rather, various modifications may be made in the details within the scope and range of equivalents of the claims and without departing from the disclosure.

What is claimed is:

1. A presentation pointer comprising:
a camera;
one or more processing circuits; and
a transmitter;
wherein the camera is configured to capture an image of a screen pointed at by the presentation pointer;
wherein the one or more processing circuits are configured to process the captured image to obtain information of the captured image; and
wherein the transmitter is configured to transmit the information of the captured image to a hosting device of a presentation.

2. The presentation pointer of claim 1, wherein the camera is a wide-angle camera, a narrow-angle camera, or a zoom camera, and wherein the captured image is more than a whole screen, a whole screen, or a partial screen of the screen pointed at by the presentation pointer.

3. The presentation pointer of claim 1, wherein the information of the captured image comprises the captured image.

4. The presentation pointer of claim 1, wherein the information of the captured image comprises coordinates of a center of the image of the screen pointed at by the presentation pointer, relative to the screen; or
wherein the information of the captured image comprises an area surrounding the center of the image of the screen pointed at by the presentation pointer.

5. The presentation pointer of claim 1, wherein a center of the image of the screen pointed at by the presentation pointer is indicated as a virtual laser spot on a concurrent virtual presentation, or indicated on both the screen and the concurrent virtual presentation.

6. The presentation pointer of claim 1, further comprising a light source, wherein the light source is configured to transmit a light beam to the screen pointed at by the presentation pointer and wherein the captured image comprises a center of the location as marked by the light beam.

7. The presentation pointer of claim 1, wherein the camera is configured to capture consecutively a plurality of images of the screen pointed at by the presentation pointer that is being held and moved by a presenter; and
wherein the one or more processing circuits are configured to obtain information of each image in the plurality of images for transmission by the transmitter.

8. The presentation pointer of claim 7, wherein the camera is configured to capture continuously the plurality of images at a frame rate of approximately 5-120 frames per second.

9. A presentation system, comprising:
a stylus, wherein the stylus comprises a camera, one or more processing circuits, and a transmitter; and
a hosting device configured to play a presentation on a first screen;
wherein the camera is configured to capture an image of a location on the presentation on the first screen at which the stylus is pointed;
wherein the one or more processing circuits are configured to process the captured image to obtain information of the captured image;
wherein the transmitter is configured to transmit the information of the captured image to the hosting device; and
wherein the hosting device is configured to receive the information of the captured image.

10. The presentation system of claim 9, wherein the hosting device is configured to display an indication of the location on the presentation on the first screen.

11. The presentation system of claim 9, wherein the indication of the location is displayed on a second screen of a device participating in a virtual session of the presentation.

12. The presentation system of claim 9, wherein the one or more processing circuits are configured to process the captured image to obtain the image of a projection screen from the captured image, and the information of the captured image comprises coordinates of a center of the captured image relative to the projection screen.

13. The presentation system of claim 9, wherein the one or more processing circuits are configured to process the captured image to obtain a small area surrounding a center of the captured image, the information of the captured image comprises the small area, and the hosting device is configured to obtain the coordinates of the center of the captured image relative to the projection screen based on the information of the captured image.

14. The presentation system of claim 9, wherein the stylus further comprises a light source configured to generate a light beam for highlighting the location on the presentation on the first screen at which the stylus is pointed.

15. The presentation system of claim 9, wherein the camera is configured to capture consecutively a plurality of images of the location on the presentation pointed at by the stylus when the stylus is being held and moved by a presenter; and
wherein the one or more processors are configured to obtain information of each image in the plurality of images for transmission by the transmitter.

16. The presentation system of claim 15, wherein the camera is configured to capture continuously the plurality of images at a frame rate of 5-120 frames per second.

17. The presentation system of claim 9, wherein the camera is a wide-angle camera, a narrow-angle camera, or a zoom camera, and wherein the captured image is more than a whole screen, a whole screen, or a partial screen of the presentation.

18. The presentation system of claim 14, wherein the indication is displayed on the second screen of the device concurrent virtual presentation or displayed on both the first screen and the second, and wherein the indication on the second screen resembles a bright spot created by the light beam.

19. The presentation system of claim 9, wherein the information of the captured image comprises coordinates of a center of the captured image relative to the projection screen.
